(19) United States
(12) Patent Application Publication
(10) Pub. No.: US 2017/0364666 A1
(43) Pub. Date: Dec. 21, 2017

(54) K-MER BASED STRAIN TYPING

(71) Applicants: Mark Fisher, Cottonwood Heights, UT (US); Keith Simmon, Salt Lake City, UT (US)

(72) Inventors: Mark Fisher, Cottonwood Heights, UT (US); Keith Simmon, Salt Lake City, UT (US)

(21) Appl. No.: 15/618,843

(22) Filed: Jun. 9, 2017

Related U.S. Application Data
(60) Provisional application No. 62/351,690, filed on Jun. 17, 2016.

(51) Int. Cl. G06F 19/00; G06F 17/30

(52) U.S. Cl. CPC G06F 19/705; G06F 17/30528

(57) ABSTRACT

At least one of the disclosed embodiments describes a computer system that enables efficient strain typing by comparing strain k-mer profiles to generate a strain typing relationship mapping. The system may include one or more processors, and one or more hardware storage devices with stored computer-executable instructions. The instructions may cause the computer system to receive a set of nucleotide sequence data. The nucleotide sequence data may include a plurality of nucleotide sequence data structures each corresponding to a separate microbial strain to be analyzed. For each nucleotide sequence data structure, a k-mer profile may be generated. K-mer profiles may be compared to determine a similarity score between the k-mer profiles, which may indicate a relationship mapping of the respective microbial strains corresponding to the k-mer profiles.

### CROSS-REFERENCE TO RELATED APPLICATIONS

This application claims priority to and the benefit of U.S. Provisional Patent Application No. 62/351,690, filed Jun. 17, 2016, and titled “K-MER BASED STRAIN TYPING,” the entirety of which is incorporated herein by this reference.

### BACKGROUND

Comparing and typing bacterial strains is important for outbreak investigation, such as tracking the source of a string of hospital infections or a food-borne illness, or determining whether two or more similar infections share a common source. Whole genome sequencing (WGS) has the potential to provide more clinically actionable information than current methods; however, the data analysis and interpretation are often more complex and computationally intensive. WGS strain typing is typically performed by alignment to a reference genome, but some strains may have DNA regions not present in the reference, leading to suboptimal alignment and suboptimal subsequent strain comparison and typing.

Further, strain typing methods using standard reference genome alignment methods are limited by the intense computational resource demands required to perform the alignment and generate the results. For example, even a comparison of a relatively small set of strains, using traditional methods, requires access to supercomputer resources or else up to days of computational time using a typical clinical laboratory computer system. In many circumstances, human health and safety depends on the speed and availability of the analysis. However, because traditional strain typing methods require such a high level of computational resources, both the rapidity in which results can be obtained and the availability of capable computer systems are limited.

### SUMMARY

In at least one of the disclosed embodiments, a computer system configured for generating a k-mer based strain type mapping is described. The system includes one or more processors, and one or more hardware storage devices having stored thereon computer-executable instructions. The instructions are executable by the one or more processors to cause the computer system to receive a set of nucleotide sequence data. The nucleotide sequence data may include a plurality of nucleotide sequence data structures each corresponding to a separate microbial strain to be analyzed.

In some embodiments, for each nucleotide sequence data structure, a k-mer profile is generated. The k-mer profile may include a set of k-mers derived from the corresponding nucleotide sequence data structure and count values corresponding to each k-mer of the set of k-mers. The count values indicate the number of times the corresponding k-mer occurs in the set of k-mers. K-mer profiles may be compared to determine a similarity score between the k-mer profiles. The similarity score may indicate a relationship mapping of the respective microbial strains corresponding to the k-mer profiles.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 illustrates an exemplary computing environment configured for strain typing based on one or more comparisons of generated k-mer profiles;

FIG. 2 illustrates an embodiment of a computer system showing various components and exemplary data flows that may be utilized for strain typing based on one or more comparisons of k-mer profiles;

FIG. 3 illustrates an example histogram output showing k-mer frequency and k-mers with a given count;

FIG. 4 illustrates a similarity matrix of the entire k-mer genome of Acinetobacter baumanii; and

FIGS. 5A-5C illustrate similarity matrices using the full k-mer set, using a k-mer reference of the core genome, and using a k-mer reference of the pan genome of Acinetobacter baumannii, respectively.

### DETAILED DESCRIPTION

The present disclosure relates to computer systems, computer-implemented methods, and computer hardware storage devices enabling efficient strain typing by comparing strain k-mer profiles to generate a strain typing relationship mapping. Various technical effects and benefits may be achieved by implementing one or more aspects of the disclosed embodiments. For example, at least some embodiments described herein solve computational efficiency problems unique to the bioinformatics and strain typing fields by enabling the generation of strain typing results without being required to calculate alignment to a reference genome.

At least some embodiments described herein enable strain typing based on pairwise comparisons of k-mer profiles associated with each analyzed strain. Each k-mer is a short nucleotide sequence length of “k” bases derived from the respective strain's sequence data. Each k-mer profile includes a generated set of k-mers of the respective strain's genome and an associated count value for each k-mer of the set, the count value indicating the number of occurrences of the corresponding k-mer within the set. By providing a set of k-mer profiles of sufficient k-mer density, one or more of the described embodiments are able to rapidly determine genomic similarities between different strains to enable strain typing analysis.

Beneficially, because the comparisons rely on relatively simple k-mer counting calculations, as opposed to more complex alignment calculations, results are achievable within a useful timeframe and/or without the need for expensive computational resources. Strain typing capabilities using at least some of the embodiments described herein have been shown to align with other standard techniques, such as pulsed-field gel electrophoresis (PFGE), indicating that accuracy and strain typing competence are not sacrificed for the higher computational efficiency gains.

In this description and in the claims, the term “computing system” or “computer architecture” is defined broadly as including any standalone or distributed device(s) and/or system(s) that include at least one physical and tangible processor, and a physical and tangible memory capable of having thereon computer-executable instructions that may be executed by the processor(s).

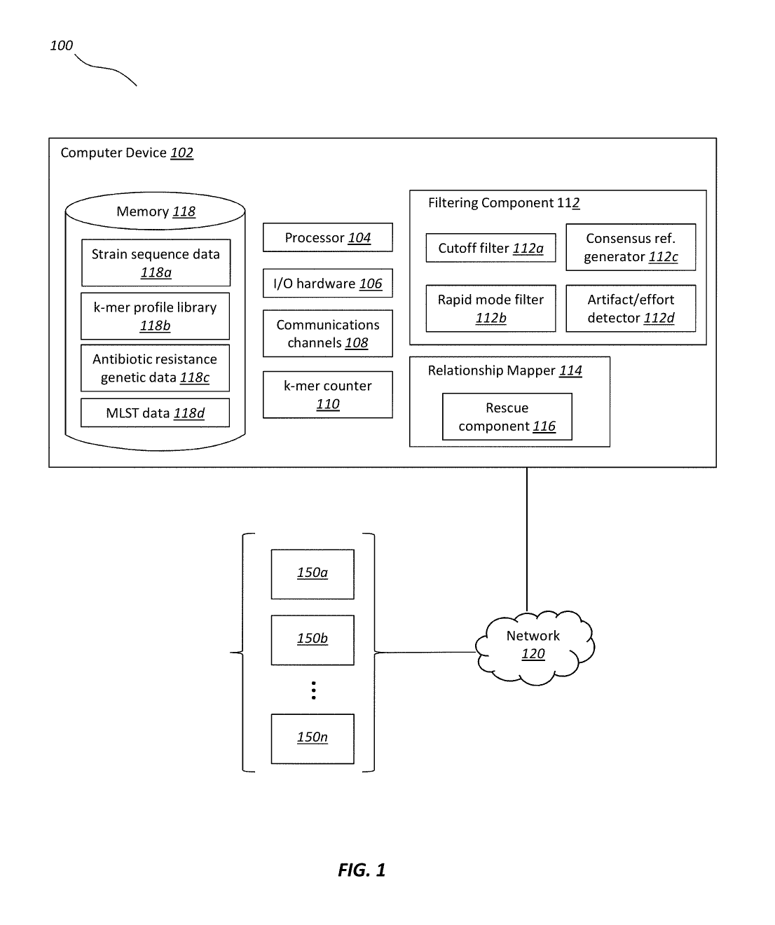

FIG. 1 illustrates an exemplary computing environment 100 configured for strain typing based on one or more comparisons of generated k-mer profiles. As shown, the illustrated computer environment 100 includes a computer device 102 with a memory 118 and at least one processor 104. Alternative embodiments may include a plurality of processors and/or memory storage devices. The memory 102 may be physical system memory, which may be volatile, non-volatile, or some combination of the two. The term “memory” may also be used herein to refer to non-volatile mass storage such as physical storage media.

The illustrated computer device 102 also includes input/output hardware 106, including one or more keyboards, mouse controls, touch screens, microphones, speakers, display screens, track balls, scroll wheels, and the like to enable the receiving of information from a user and for displaying or otherwise communicating information to a user.

The illustrated computer device 102 includes communication channels 108 that enable the computer device 102 to communicate with one or more separate computer systems. For example, the computer system 100 may be a part of network 120, which may be configured as a Local Area Network (“LAN”), a Wide Area Network (“WAN”), or the Internet, for example. In some embodiments, the computer system 100 communicates with and/or is part of a distributed computer environment 150, as indicated by the plurality of separate computer systems 150a through 150n.

The computer device 102 includes executable modules or executable components 110-116. As used herein, the term “executable module” or “executable component” can refer to software objects, routings, or methods that may be executed on the computing system. The different components, modules, engines, and services described herein may be implemented as objects or processes that execute on the computing system (e.g., as separate threads).

The various components illustrated in FIG. 1 represent only a few example implementations of a computer system configured for strain typing based on one or more comparisons of generated k-mer profiles. Other embodiments may divide the described memory/storage, modules, components, and/or functions differently among additional computer systems. In some embodiments, memory components and/or program modules are distributed across a plurality of constituent computer systems in a distributed environment. In other embodiments, memory components and program modules are included in a single integrated computer system. Accordingly, the systems and methods described herein are not intended to be limited based on the particular location at which the described components are located and/or at which their functions are performed.

As shown, the illustrated memory 118 includes strain sequence data 118a, which may include, for example, one or more text-based files (e.g., files in FASTA format, FASTQ format, etc.) representing nucleotide sequences of one or more microbial strains selected for typing through k-mer profile comparison. The illustrated memory 118 also includes a k-mer profile library 118b, which may include previously generated or previously analyzed k-mer profiles. For example, the k-mer profile library 118b may include k-mer profiles previously generated at the computer device 102. Additionally, or alternatively, the k-mer profile library 118b may include one or more k-mer profiles downloaded or accessed from another computer device (e.g., from one or more of computer devices 150-150n through network 120) or from a relevant bioinformatics database. In the illustrated embodiment, the memory 118 also includes antibiotic resistance gene data 118c and multilocus sequence typing (MLST) data 118d. These data may be stored locally and/or retrieved from a relevant bioinformatics database.

The illustrated embodiment also includes a k-mer counter 110 configured to receive strain sequence data 118a and to generate one or more associated k-mer profiles. For example, for each strain sequence, the k-mer counter 110 is operable to generate a k-mer profile indicating the number of times each k-mer derived from the sequence data is present within the sequence data. Generated k-mer profiles may be stored in the k-mer profile library 118b. In some embodiments, each k-mer is generated by moving one base pair at a time, such that the number of k-mers substantially equals the size of the genome. The k-mer size is selected to be long enough to provide a sufficient number of unique k-mers, but not so overly long as to detrimentally degrade computational performance. For example, k-mer length may be within the range of about 18-60 base pairs, or more preferably within the range of about 21-31 base pairs.

The illustrated embodiment includes a filtering component 112 operable to enable filtering of the one or more k-mer profiles generated by the k-mer counter 110 or received through another source. For example, one or more of the illustrated sub-components 112a-112d of the filtering component 112 may be utilized to reduce the size of a particular k-mer profile and/or set of k-mer profiles, enabling more rapid and efficient comparison(s) of k-mer profiles while maintaining the ability to make informative comparisons and effective strain typing results.

The illustrated cutoff filter 112a is operable to filter/exclude those k-mers that, for a particular k-mer profile, are likely to be the result of sequencing errors and are therefore best excluded from comparative analysis of the particular k-mer profile with other k-mer profiles. In some embodiments, the cutoff filter 112a is configured to set a cutoff that excludes k-mers having counts that fall below a cutoff threshold. In some embodiments, the cutoff threshold is set proportionally to an estimated coverage of the corresponding sequence data. For example, for sequence data associated with an error rate of about 0.1-1.0%, it has been found that multiplying the estimated coverage by cutoff multiplier of about 0.2 (e.g., 0.05 to 0.4, 0.1 to 0.3, or 0.15 to 0.25) provides a suitable cutoff threshold. Excluding k-mers having counts below the cutoff threshold was found to remove sufficient proportion of error k-mers. In circumstances where sequence data is associated with particular values within the 0.1-1.0% range, or with higher or lower error rates, the cutoff multiplier can be adjusted accordingly.

Other embodiments additionally or alternatively determine a cutoff filter threshold by generating a distribution (e.g., a Poisson distribution) for a given set of sequences and determining a confidence level, based on the distribution, that a frequency of a particular count value fits an expected distribution.

In some embodiments, the coverage of a particular strain's sequence data is estimated by determining a total k-mer count for the sequence data, and dividing the total k-mer count by the number of distinct k-mers within the sequence data. In a simplified example, a sequence having 10 distinct k-mers, each counted 15 times (making the total k-mer count equal to 10×15=150), would have an estimated coverage of 150/10=15×. In some embodiments, k-mers having a count of about 3 or less, or some other default threshold value, are excluded from the coverage estimation operation. Results have shown that, at least for sequence data associated with an error rate of about 0.1-1.0%, coverage of about 25× enables the derivation of substantially all of the k-mers of the sequence and the effective filtering of erroneous k-mers. The genome size of a particular strain may also be estimated as being equal to the number of distinct k-mers having a count greater than or equal to the determined cutoff filter threshold.

The illustrated embodiment also includes a rapid mode filter 112b operable to enable selective filtering of a k-mer profile to a relatively smaller set of k-mers in order to further reduce computational requirements for one or more k-mer profile comparisons. For example, the rapid mode filter 112b may be configured to obtain a k-mer profile subset of k-mers starting with “ag” or some other default and/or user-selected subset definition. The resulting subset is still randomly dispersed throughout the genome and therefore still provides effective strain typing capabilities, even though the number of k-mers required to make a particular comparison may be drastically reduced.

The illustrated embodiment also includes a consensus reference generator 112c operable to generate a consensus k-mer profile and to selectively use the consensus k-mer profile to filter one or more strain k-mer profiles. For example, a consensus k-mer profile for a microbial species may represent k-mers common within a default or selected percentage (e.g., about 60-90%, 75-85%, or other desired commonality level) of strains of the microbial species. The consensus k-mer profile may then be utilized to filter one or more strain k-mer profiles. For example, in some implementations, a comparison is carried out using only k-mers within the consensus k-mer profile (i.e., a “core” genome comparison), while in other implementations, a comparison is carried out using only the k-mers not within the consensus k-mer profile (i.e. a “pan” genome comparison).

Each different type of consensus reference filtering has different benefits that may be selectively utilized to align with different analytical needs. For example, a core genome comparison provides an analysis of k-mer profiles strongly associated with the particular microbial species, where k-mer profile differences of different strains may have less relative numeric magnitude but nevertheless have great effect in strain differentiation. On the other hand, a pan genome comparison is likely to provide greater resolution and distinction of different strains' different k-mer profiles by avoiding dilution from the common consensus k-mers.

The illustrated embodiment also includes an artifact/error detector 112d which is operable to detect likely erroneous k-mers and selectively exclude them. For example, the artifact/error detector 112d may be configured to detect and exclude k-mers having a complexity level failing to reach a predetermined threshold (e.g., a k-mer having an overly long string of a single base pair), indicating that the k-mer is likely a sequencing artifact.

The artifact/error detector 112d may also be configured to analyze the total k-mer count for a particular strain's k-mer profile. One or more strains may be indicated as potentially contaminated by comparing the total k-mer count to the estimated genome size. For example, where a total k-mer count for a particular strain's k-mer profile is approximately double the estimated or expected genome size, the artifact/error detector 112d may be operable to flag the k-mer profile as being likely contaminated. In other circumstances, such as where the total k-mer count is about 10-30% higher than estimated or expected, or some other fraction less than approximately 100% higher than estimated or expected, the artifact/error detector 112d may be configured to determine that the increase is due to plasmid(s) as opposed to a contamination event. The particular cutoff values used for generating flagging and/or contamination probability scores may be tuned according to user preferences, empirical determinations, desired sensitivity to potential contamination, and the like.

As shown, the computer device 102 also includes a relationship mapper 114 configured to compare a k-mer profile against one or more other k-mer profiles. For example, the relationship mapper 114 may be configured to perform pairwise comparisons of each strain of a set against each other strain of the set in order to determine a k-mer similarity score. In some embodiments, a similarity score between two strains being compared is generated by dividing the number of shared k-mers by the total number of k-mers between the strains.

The illustrated relationship mapper 114 also includes a rescue component 116 configured to enable comparative analysis in circumstances where one or more strains have sequence data with coverage that is lower than ideal and/or that is expected as being contaminated. For such sequence data, the foregoing similarity score determination may be substituted for a determination that divides the number of shared k-mers by the number of k-mers of the lower coverage strain of the particular pairwise comparison. For example, where a particular k-mer profile of a set of profiles to be compared has low coverage (e.g., less than 25×), the rescue component 116 can operate to make a pairwise comparison using the low-coverage sequence by diving the number of shared k-mers of the low-coverage and higher-coverage profiles by the total number of k-mers of the lower-coverage k-mer profile.

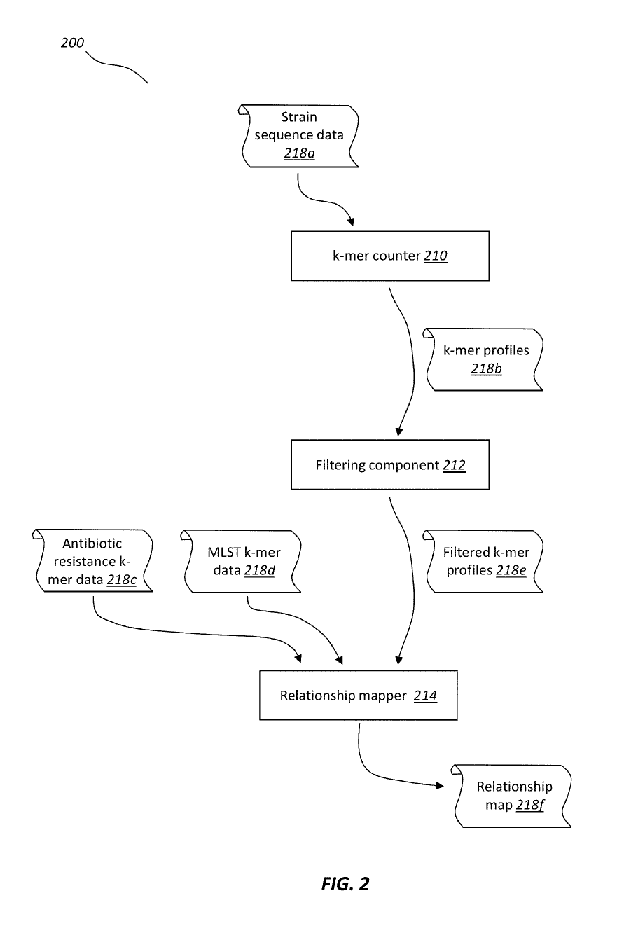

FIG. 2 illustrates an embodiment of a computer system 200 showing various components and exemplary data flows that may be utilized for strain typing based on one or more comparisons of k-mer profiles. The components illustrated in FIG. 2 may be similar to the components illustrated and described in relation to FIG. 1. As shown, a k-mer counter 210 is configured to receive strain sequence data 218a and to generate a set of k-mer profiles 218b. A filtering component 212 is configured to receive the k-mer profiles 218b and generate a set of filtered k-mer profiles 218e. The filtering component 212 is operable to enable filtering based on one or more of a cutoff filter, a rapid-mode filter (e.g., all k-mers starting with “gc”), a consensus reference filter (e.g., to enable core or pan genome comparisons), or an artifact/error filter, for example.

In the illustrated embodiment, a relationship mapper 214 is configured to receive the filtered k-mer profiles 218e and to generate a relationship map 218f based on one or more comparisons between different k-mer profiles, the one or more comparisons indicating similarity between k-mer profiles based on k-mer count similarities (e.g., number of shared k-mers divided by total number of k-mers between two k-mer profiles).

As shown, the relationship mapper 214 may also receive one or more of antibiotic resistance k-mer data 218c or MLST k-mer data 218d. These data may additionally or alternatively be compared with a k-mer profile to map antibiotic resistance of a strain and/or to identify MLST types. In some embodiments, the relationship mapper 214 compares a k-mer profile with antibiotic resistance k-mer data to generate count values for k-mers present in the particular strain's k-mer profile that are associated with antibiotic resistance, with higher count values suggesting that the particular strain includes antibiotic resistance genes on a plasmid.

In at least one embodiment, the filtering component 212 and/or relationship mapper 214 is configured to annotate the strains to evaluate the quality of each sequence, indicate the k-mers excluded from analysis, and/or estimate genome size.

Embodiments of the present invention may comprise or utilize a special-purpose or general-purpose computer system that includes computer hardware, such as, for example, one or more processors and system memory. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

### Examples

Raw sequence files from both internal and previously published data for >125 isolates were filtered for low-quality k-mers. Jellyfish, a command-line operated program that reads FASTA and multi-FASTA files was used to count k-mers. 31 base-pair k-mers were used, with each k-mer being generated by sliding one base down at a time. Rarefaction analysis to determine optimal sequence coverage was performed by calculating the number of reads required to obtain the estimated distinct k-mer count. Genome size was also estimated.

We observed that excluding k-mers with count <0.2% of the estimated coverage was suitable for removing error k-mers. Greater than 25× coverage was needed to optimally obtain counts needed to observe nearly all the k-mers that are derived from the genome and to filter poor quality k-mers effectively.

To detect genes with functional antibiotic mechanisms, antibiotic resistant gene data was downloaded from CARD manually and the appropriate resource files were placed in a date directory. To detect MLST type, MLST data for each MLST gene and a text profile file containing the strain type (ST) and corresponding sequence identifier for each of the genes in the profile was downloaded from pubmlst. The k-mer content for each sequence was determined and the information was stored as a resource file. When strains are compared, each gene regardless of source is screened. If a MLST gene shared 100% kID with a queried strain it was marked as a match.

Rarefaction curves show that nearly all k-mers were observed when average sequence coverage is ≧25×. Strain comparisons were performed in ˜5-10 min for ˜20 strains, with a rapid mode allowing comparisons in <5 min. For example, 15 strains with technical replicates (n=30) were processed in 11 minutes (4:30 in rapid mode) using 12 computer processing units (CPU), 17 strains with technical replicates (n=34) were processed in 11 minutes (4:30 in rapid mode) using 12 CPUs, and 19 strains with technical replicates (n=38) were processed in 12 minutes (4:30 in rapid mode) using 12 CPUs. Dendrograms created from k-mer distance matrices showed strain relationships very similar to those derived from reference genome alignment. Mean k-mer identity was 99.8% for replicates. Mean k-mer identity for PFGE categories of identical, closely/possibly related, different k-mer profiles were 99.2%, 94.6%, and 58.3%, respectively.

TABLE 1
Rarefaction analysis of distinct k-mers recovers per number of reads analyzed
for Acinetobacter baumannii (1). K-mers with a count <3 were ignored, a running k-
mer count cutoff was determined at each step by calculating a cutoff filter (see FIG.
2). The inset table shows the k-mer recovered from technical replicates of 14 isolates.
Differences in k-mer count are correlated with inadequate coverage (<25X) of one of
the replicates. For replicates with greater the 20X coverage (n = 6) the number of distinct
k-mers varies an average of 0.10%. The max difference between non-replicates is 3.8%.

| | | Avg | Difference | | |
|---|---|---|---|---|---|
| | Difference in | replicate | in kmer | Estimated Coverage | |
| Sample | kmer count | kmer count | count | Replicate A | Replicate B |
| AS | 3.21% | 3967937 | 127225 | 11.7 | 28.2 |
| Al | 1.51% | 4004510 | 60619 | 13.5 | 40.2 |
| A8 | 0.74% | 3940738 | 29052 | 24.5 | 14.9 |
| A16 | 0.44% | 3964907 | 17471 | 18.8 | 56.4 |
| A6 | 0.34% | 4027432 | 13790 | 18.7 | 45.7 |
| Alt | 0.33% | 4023659 | 13242 | 17.1 | 30.5 |
| All | 0.27% | 3886848 | 10643 | 30.3 | 59.1 |
| A15 | 0.13% | 3963636 | 5041 | 22.8 | 36.3 |
| A14 | 0.12% | 3962683 | 4621 | 35.2 | 22.2 |
| A7 | 0.09% | 3962681 | 3702 | 23.9 | 36.6 |
| A2 | 0.06% | 3956205 | 2250 | 23.3 | 26.2 |
| A13 | 0.06% | 4030396 | 2233 | 33.2 | 26.3 |
| Al0 | 0.04% | 4028096 | 1647 | 28.8 | 24.3 |
| A3 | 0.03% | 3879753 | 1192 | 23.7 | 25.3 |

TABLE 2
Rarefaction analysis of distinct k-mers recovers per number of reads analyzed
for methicillin resistant Staphylococcus aureus (1). K-mers with a count <3 were
ignored, a running k-mer count cutoff was determined at each step by calculating a
cutoff filter. The inset table shows the k-mer recovered from technical replicates of 14
isolates. Differences in k-mer count are correlated with inadequate coverage (<25X) of
one of the replicates. For replicates with greater the 20X coverage (n = 17) the number of
distinct k-mers varies an average of 0.09%. The max difference between non-replicates
is 4.5%.

| | | Avg | Difference | | |
|---|---|---|---|---|---|
| | Difference in | replicate | in kmer | Estimated coverage | |
| Sample | kmer count | kmer count | count | Replicate A | Replicate B |
| M2 | 0.25% | 2844310 | 7087 | 68.6 | 27.3 |
| M8 | 0.19% | 2846745 | 5484 | 30.8 | 65.2 |
| M13 | 0.19% | 2853846 | 5360 | 62.3 | 83.7 |
| M18 | 0.16% | 2828192 | 4449 | 59.2 | 33 |
| Ml6 | 0.14% | 2848735 | 4117 | 63.1 | 42.6 |
| M3 | 0.13% | 2826958 | 3646 | 30.9 | 56 |
| M7 | 0.11% | 2845082 | 3150 | 27.3 | 46.4 |
| M9 | 0.08% | 2858941 | 2270 | 33.8 | 50.1 |
| M 15 | 0.07% | 2827689 | 2030 | 43.6 | 50.7 |
| M6 | 0.05% | 2798235 | 1321 | 38.6 | 51.7 |
| M 12 | 0.03% | 2734343 | 836 | 42.6 | 34.9 |
| M19 | 0.03% | 2767650 | 876 | 36.3 | 25.7 |
| M 11 | 0.03% | 2769324 | 811 | 45.1 | 40.4 |
| M20 | 0.03% | 2746025 | 777 | 48.9 | 47.8 |
| M10 | 0.02% | 2841219 | 612 | 32.2 | 33.5 |
| Ml | 0.02% | 2843167 | 706 | 41.5 | 28.2 |
| M17 | 0.00% | 2845514 | 104 | 40.2 | 39.9 |

TABLE 3
Rarefaction analysis of distinct k-mers recovers per number of reads analyzed
for vancomycin-resistant Enterococcus (1). K-mers with a count <3 are ignored, a
running k-mer count cutoff is determined at each step by calculating a cutoff filter (see
FIG. 2). The inset table shows the k-mer recovered from technical replicates of 14
isolates. Differences in k-mer count are correlated with inadequate coverage (<25X) of
one of the replicates. For replicates with greater the 20X coverage (n = 17) the number of
distinct k-mers varies an average of 0.15%. The max difference between non-replicates
is 7.3%.

| | | Avg | Difference | | |
|---|---|---|---|---|---|
| | Difference in | replicate | in kmer | Estimated coverage | |
| Sample | kmer count | kmer count | count | Replicate A | Replicate B |
| M2 | 0.25% | 2844310 | 7087 | 68.6 | 27.3 |
| M8 | 0.19% | 2846745 | 5484 | 30.8 | 65.2 |
| M 13 | 0.19% | 2853846 | 5360 | 62.3 | 83.7 |
| MlS | 0.16% | 2828192 | 4449 | 59.2 | 33 |
| M16 | 0.14% | 2848735 | 4117 | 63.1 | 42.6 |
| M3 | 0.13% | 2826958 | 3646 | 30.9 | 56 |
| M7 | 0.11% | 2845082 | 3150 | 27.3 | 46.4 |
| M9 | 0.08% | 2858941 | 2270 | 33.8 | 50.1 |
| M 15 | 0.07% | 2827689 | 2030 | 43.6 | 50.7 |
| M6 | 0.05% | 2798235 | 1321 | 38.6 | 51.7 |
| M 12 | 0.03% | 2734343 | 836 | 42.6 | 34.9 |
| M19 | 0.03% | 2767650 | 876 | 36.3 | 25.7 |
| Ml1 | 0.03% | 2769324 | 811 | 45.1 | 40.4 |
| M20 | 0.03% | 2746025 | 777 | 48.9 | 47.8 |
| MlO | 0.02% | 2841219 | 612 | 32.2 | 33.5 |
| Ml | 0.02% | 2843167 | 706 | 41.5 | 28.2 |
| M17 | 0.00% | 2845514 | 104 | 40.2 | 39.9 |

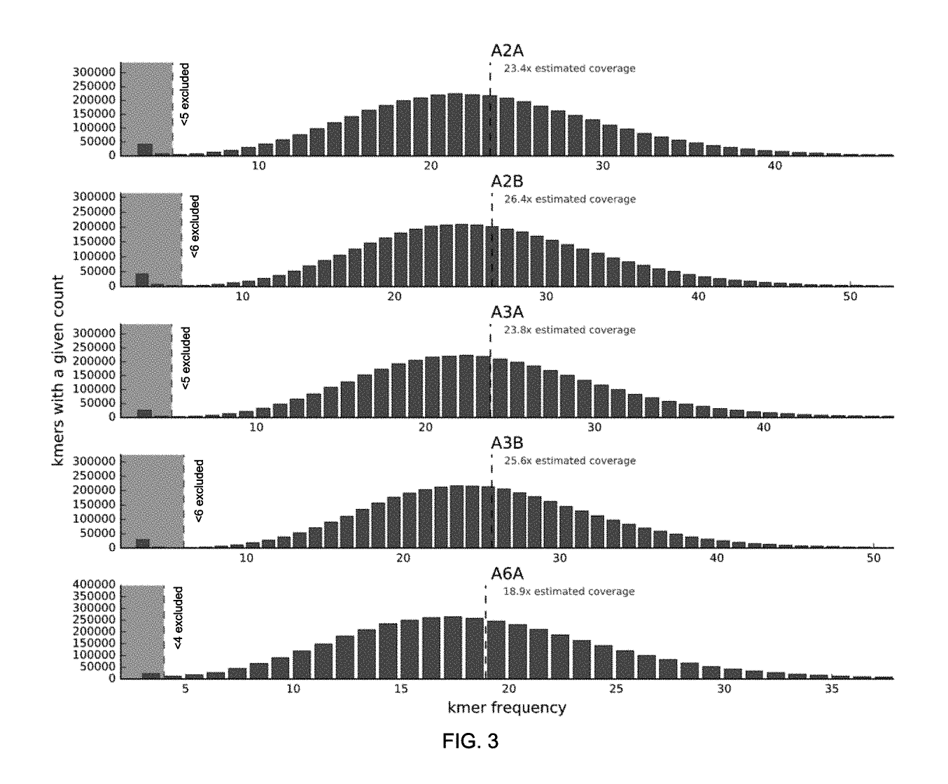

FIG. 3 shows an example histogram output. Each histogram represents a unique sample input. The shaded area at the left of each histogram shows the k-mers that were excluded from the final k-mer set. The estimated coverage is reported for each isolate.

A pairwise filter that compared altered k-mers between strains was initiated when two strain shared >85% kID. K-mers were excluded from the analysis if they were low complexity (homo-polymer runs (3 runs summing to 12), half the k-mer a single base), the k-mer count was close to the k-mer cutoff (within 3), the k-mer had excessive coverage, or the k-mer was found below the initial cutoff with a count >3.

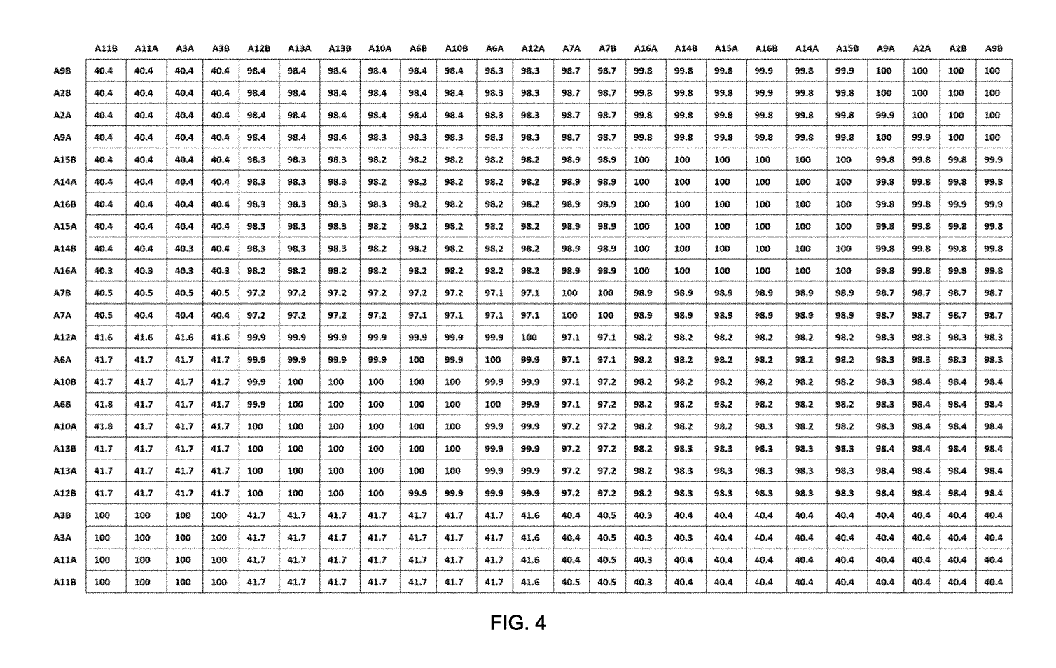

FIG. 4 shows a similarity matrix of the entire k-mer genome of Acinetobacter baumanii. Isolates with technical replicates with greater than >20× coverage are included. All technical replicate have >99.9% kID to each other. Analysis was performed using the entire dataset with pairwise k-mer filtering.

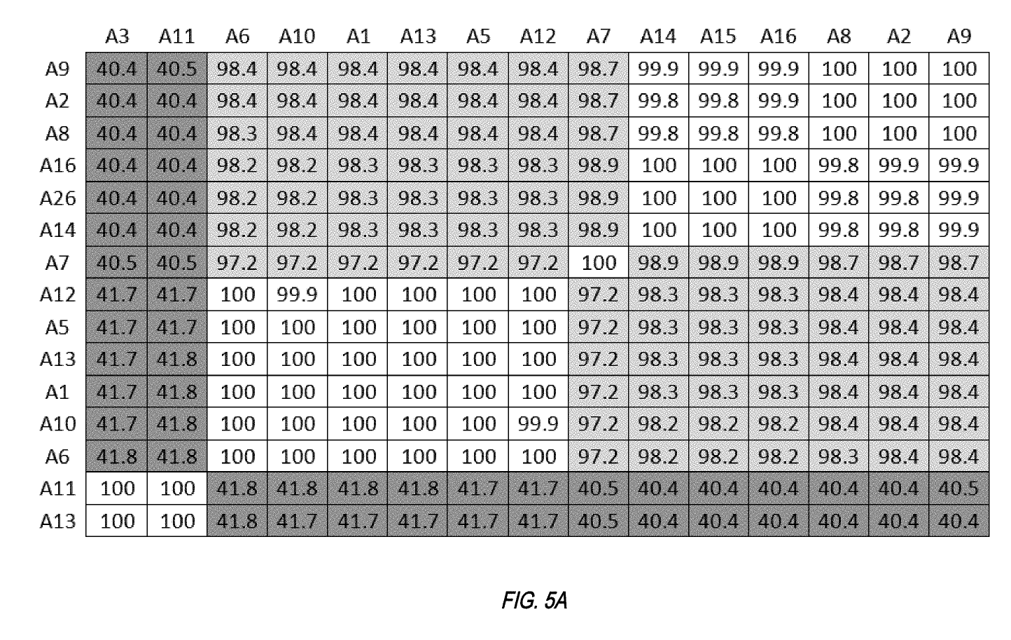

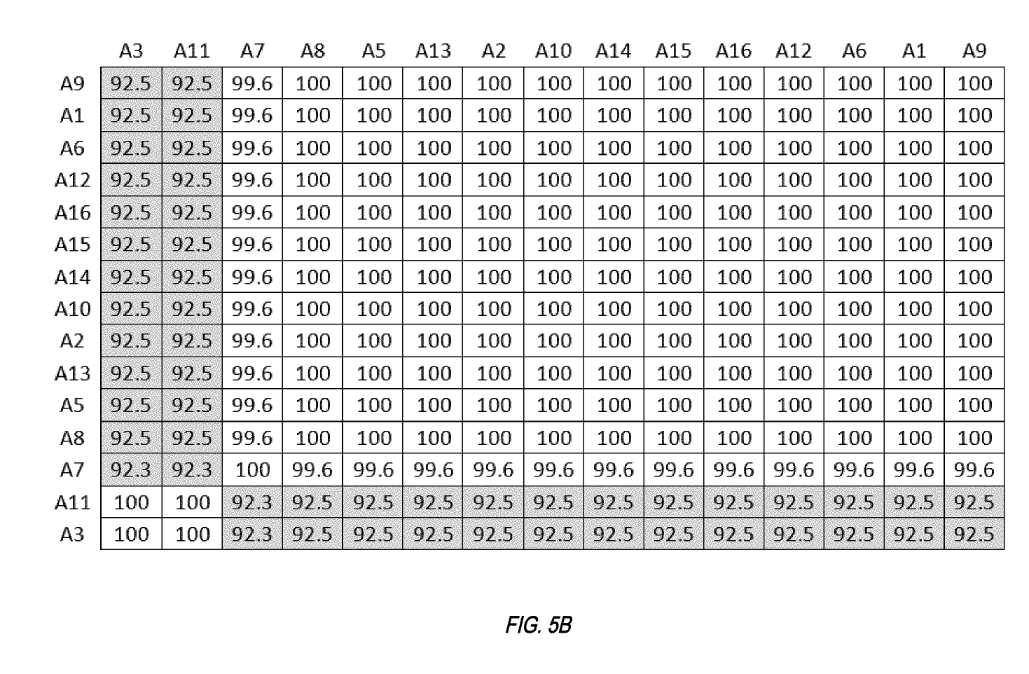

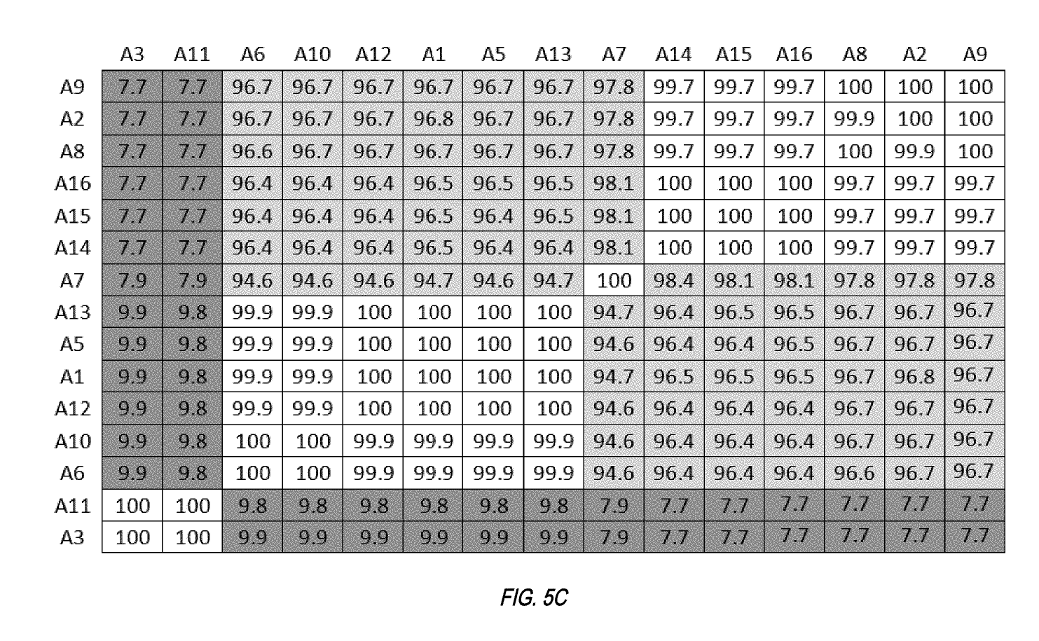

FIG. 5A shows a similarity matrix of using the full k-mer set. FIG. 5B shows a similarity matrix of using a k-mer reference of the Acinetobacter baumannii core-genome. FIG. 5C shows a similarity matrix of excluding k-mers from the k-mer reference of the Acinetobacter baumannii core-genome (i.e pan-genome).

What is claimed is:

1. A computer system configured for generating a k-mer based strain type mapping, the computer system comprising:
one or more processors; and
one or more hardware storage devices having stored thereon computer-executable instructions which are executable by the one or more processors to cause the computer system to perform at least the following:
receive a set of nucleotide sequence data, the nucleotide sequence data including a plurality of nucleotide sequence data structures each corresponding to a separate microbial strain to be analyzed;
for each nucleotide sequence data structure, generate a k-mer profile including a set of k-mers derived from the corresponding nucleotide sequence data structure and count values corresponding to each k-mer of the set of k-mers, the count values indicating the number of times the corresponding k-mer occurs in the set of k-mers; and
compare a first k-mer profile to at least one other k-mer profile to determine a similarity score between the first k-mer profile and the at least one other k-mer profile, the similarity score indicating a relationship mapping of the respective microbial strains corresponding to the first k-mer profile and the at least one other k-mer profile.

2. The computer system of claim 1, wherein the k-mer profiles are configured with a length of about 18-60 bases, or about 21-31 bases.

3. The computer system of claim 1, wherein the computer-executable instructions are also executable by the one or more processors to cause the computer system to filter the k-mer profiles prior to comparing the first k-mer profile to the at least one other k-mer profile in order to reduce the number of k-mers within each compared k-mer profile.

4. The computer system of claim 3, wherein filtering of the k-mer profiles includes determining a cutoff filter, the cutoff filter being operable to exclude k-mers having count values falling below a cutoff threshold.

5. The computer system of claim 4, wherein the cutoff threshold for each k-mer profile is proportional to a determined coverage for the sequence corresponding to the k-mer profile.

6. The computer system of claim 3, wherein filtering of the k-mer profiles includes determining a cutoff filter, the cutoff filter being operable to exclude k-mers identified as erroneous according to a Poisson distribution of a respective k-mer profile.

7. The computer system of claim 3, wherein filtering of the k-mer profiles includes generating a subset of k-mers according to a rapid-mode filter.

8. The computer system of claim 3, wherein the filtering of the k-mer profiles includes generating a consensus reference and filtering the k-mer profiles according to the consensus reference.

9. The computer system of claim 8, wherein the k-mer profiles are filtered by excluding k-mers shared with the consensus reference so as to enable a pan genome comparison.

10. The computer system of claim 8, wherein the k-mer profiles are filtered by excluding the k-mers that are not shared with the consensus reference so as to enable a core genome comparison.

11. The computer system of claim 3, wherein the filtering of the k-mer profiles includes detecting one or more sequencing artifacts or errors and excluding k-mers associated with the one or more sequencing artifacts or errors.

12. The computer system of claim 1, wherein the comparing a first k-mer profile to at least one other k-mer profile includes comparing the first k-mer profile to an antibiotic-resistance k-mer profile.

13. The computer system of claim 1, wherein the comparing a first k-mer profile to at least one other k-mer profile includes comparing the first k-mer profile to a multilocus sequence typing k-mer profile.

14. A method for generating a k-mer based strain type mapping, the method comprising:
receiving a set of nucleotide sequence data, the nucleotide sequence data including a plurality of nucleotide sequence data structures each corresponding to a separate microbial strain to be analyzed;
generating a k-mer profile for each nucleotide sequence data structure, the k-mer profile including a set of k-mers derived from the corresponding nucleotide sequence data structure and count values corresponding to each k-mer of the set of k-mers, the count values indicating the number of times the corresponding k-mer occurs in the set of k-mers; and
comparing a first k-mer profile to at least one other k-mer profile to determine a similarity score between the first k-mer profile and the at least one other k-mer profile, the similarity score indicating a relationship mapping of the respective microbial strains corresponding to the first k-mer profile and the at least one other k-mer profile.

15. The method of claim 14, wherein the method further comprises filtering the k-mer profiles prior to comparing the first k-mer profile to the at least one other k-mer profile in order to reduce the number of k-mers within each compared k-mer profile.

16. The method of claim 15, wherein the filtering of the k-mer profiles further comprises determining a cutoff filter, the cutoff filter being operable to exclude k-mers identified as erroneous according to a Poisson distribution of a respective k-mer profile.

17. The method of claim 15, wherein the filtering of the k-mer profiles further comprises generating a consensus reference and filtering the k-mer profiles according to the consensus reference.

18. A computer system configured for generating a k-mer based strain type mapping, the computer system comprising:
one or more processors; and
one or more hardware storage devices having stored thereon computer-executable instructions which are executable by the one or more processors to cause the computer system to perform at least the following:
receive a set of nucleotide sequence data, the nucleotide sequence data including a plurality of nucleotide sequence data structures each corresponding to a separate microbial strain to be analyzed;
for each nucleotide sequence data structure, generate a k-mer profile configured with a length of about 18-60 bases, the k-mer profile including a set of k-mers derived from the corresponding nucleotide sequence data structure and count values corresponding to each k-mer of the set of k-mers, the count values indicating the number of times the corresponding k-mer occurs in the set of k-mers;
filter the k-mer profiles in order to reduce the number of k-mers within each compared k-mer profile; and
compare a first k-mer profile to at least one other k-mer profile to determine a similarity score between the first k-mer profile and the at least one other k-mer profile, the similarity score indicating a relationship mapping of the respective microbial strains corresponding to the first k-mer profile and the at least one other k-mer profile.

19. The computer system of claim 18, wherein filtering of the k-mer profiles includes determining a cutoff filter, the cutoff filter being operable to exclude k-mers having count values falling below a cutoff threshold.

20. The computer system of claim 18, wherein filtering of the k-mer profiles includes generating a consensus reference and filtering the k-mer profiles according to the consensus reference.
